(19) United States
(12) Patent Application Publication
(10) Pub. No.: US 2007/0019018 A1
(43) Pub. Date: Jan. 25, 2007

(54) Printing device and printing method

(75) Inventor: Yoichi Wakai, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/340,809

(22) Filed: Jan. 25, 2006

(30) Foreign Application Priority Data
Jan. 26, 2005 (JP) 2005-17682

(51) Int. Cl. B41J 29/38

(52) U.S. Cl. 347/14

(57) ABSTRACT

A printing device of the invention is capable of directly reading and printing images recorded in a recording medium. The printing device of the invention first selects one representative image from each of multiple folders set in a medium and prints a representative image order sheet where the selected representative images are arranged as image indexes. After the user's selection of a desired representative image in the printed representative image order sheet, the printing device prints a print image order sheet where images in a specified folder including the user's selected representative image are arranged as image indexes. The user selects one or multiple desired images for printing among the images printed on the print image order sheet. The printing device of the invention uses the two different order sheets and thereby facilitates the user's selection of desired images in a hierarchical manner. This arrangement enables the user to efficiently select desired images for printing among a large mass of images. The printing device of the invention then prints the user's desired images efficiently selected among the large mass of images.

### CLAIM OF PRIORITY

The present application claims the priority from Japanese application P2005-17682A filed on Jan. 26, 2005, the contents of which are hereby incorporated by reference into this application.

### BACKGROUND OF THE INVENTION

1. Field of the Invention

The present invention relates to a printing device that reads and processes images recorded in a recording medium, as well as to a corresponding processing method.

Many of commonly used printing devices are capable of directly reading and printing image data recorded in a memory card without using an independent personal computer. Among such printing devices, a printing device disclosed in Japanese Patent Laid-Open Gazette No. 2003-266880 backs up images read from a memory card in a medium, such as an MO or a CD-R, that is set in an external storage unit connected to the printing device via a USB interface or another suitable interface.

Another popular structure added to the printing device is a monitor for preview display of object images to be printed. The printing device of this structure displays images recorded in a memory card on the monitor and thus enables the user to readily select desired image for printing among the images recorded in the memory card.

2. Description of the Related Art

The monitor mounted on the printing device is, however, generally small in size and enables simultaneous display of only several images. The limited display on the small-size monitor forces the user to consume an immense amount of time for selection of all the desired images for printing among a large mass of backup images stored in a high-capacity external storage unit.

In complex machines having the integral functions of a printer and a scanner, one proposed method prints an order sheet including a list of images recorded in a memory card and enables the user to select desired images for printing among the printed images on the order sheet. Printing an image list including a large mass of images on multiple order sheets, however, undesirably increases the consumption of ink and paper.

### SUMMARY

The object of the invention is thus to eliminate the drawbacks of the prior art techniques and to provide a technique that is applied to a printing device, which is capable of directly reading and printing images recorded in a recording medium, and enables the user to efficiently select desired images for printing among a large mass of images.

In order to attain at least part of the above and the other related objects, the aspect of the present invention is directed to a printing device that reads and processes images recorded in a recording medium. The printing device includes: a representative image selection module that selects a representative image from each of multiple image groups recorded in the recording medium; a first order sheet printing module that prints a first order sheet, where the representative images selected by the representative image selection module are arranged as image indexes and first identification marks for identifying the respective representative images are provided corresponding to the representative images; an image group identification module that receives a user's selection of a representative image based on a corresponding first identification mark and identifies an image group including the user's selected representative image among the multiple image groups; a second order sheet printing module that prints a second order sheet, where images included in the image group identified by the image group identification module are arranged as image indexes and second identification marks for identifying the respective images are provided corresponding to the images; an image identification module that receives the user's selection of at least one image based on a corresponding second identification mark and identifies the user's selected at least one image in the image group identified by the image group identification module; and a processing module that reads the at least one image identified by the image identification module from the recording medium and processes the at least one image read from the recording medium.

The printing device first prints the first order sheet where the selected representative images are arranged as image indexes and subsequently prints the second order sheet where the images in the identified image group including the user's selected representative image on the printed first order sheet are arranged as image indexes. The printing device uses these two different order sheets and thereby facilitates the user's selection of desired images for printing in a hierarchical manner. This arrangement enables the user to efficiently select desired images for printing among a large mass of images recorded in a recording medium.

In one typical structure of the printing device of the invention, the processing module prints the at least one image read from the recording medium.

The printing device of this structure enables the user to efficiently print desired images without using an independent personal computer. The processing executed by the processing module is not restricted to the printing operation of printing the images read from the recording medium, but may be a display operation of showing the images read from the recording medium on a liquid crystal display mounted on the printing device or may be any of various image processing operations including trimming and color correction.

In one preferable application of the printing device of the invention, the recording medium stores the multiple image groups respectively recorded in multiple different folders. The representative image selection module selects a representative image among images recorded in each of the multiple different folders according to a predetermined rule.

The printing device of this application ensures easy selection of the representative images. In the printing device of this application, for example, the representative image selection module may select either a first image or a last image in a recording order among the images recorded in each folder, as the representative image. In another example, the representative image selection module may select representative images at random from respective folders.

In another preferable application of the printing device of the invention, each of the images recorded in the recording medium has time-related information. The representative image selection module collects images having a time stamp of an identical date, an identical month, or an identical year into one image group and selects a representative image out of each image group according to a predetermined rule.

The printing device of this application also ensures easy selection of the representative images. In the printing device of this application, for example, the representative image selection module may select an image having an earliest time stamp, a latest time stamp, or an intermediate time stamp among the images included in each image group, as the representative image.

In another example, the representative image selection module may select representative images at random from respective image groups.

In one preferable embodiment of the printing device of the invention, the first order sheet printing module prints a first marking field, which is to be filled in by the user with a writing instrument in response to the user's selection, as the first identification mark. The second order sheet printing module prints a second marking field, which is to be filled in by the user with the writing instrument in response to the user's selection, as the second identification mark.

The printing device of this preferable embodiment may be connected with a scanner. The image group identification module controls the scanner to scan the first order sheet and receives a representative image specified by the user's fill-in operation in a corresponding first marking field, as the user's selection of the representative image. The image identification module controls the scanner to scan the second order sheet and receives at least one image specified by the user's fill-in operation in a corresponding second marking field, as the user's selection of the at least one image.

This structure enables the user to readily select desired images for printing among a large mass of images by the simple operation of filling in the marking fields corresponding to the desired representative image and corresponding to the at least one desired image for printing on the first and the second order sheets with the writing instrument.

In another preferable embodiment of the printing device of the invention, the first order sheet printing module prints a barcode inherently allocated to each of the representative images, as the first identification mark. The second order sheet printing module prints a barcode inherently allocated to each of the images, as the second identification mark.

The printing device of this preferable embodiment may be connected with a barcode reader. The image group identification module receives the user's selection of the representative image, in response to a barcode reading signal received from the barcode reader. The image identification module receives the user's selection of the at least one image, in response to a barcode reading signal received from the barcode reader.

This structure enables the user to readily select desired images for printing among a large mass of images by the simple operation of the barcode reader to read the barcodes inherently allocated to the desired representative image and allocated to the at least one desired image for printing on the first and the second order sheets.

In one preferable application of the invention, the printing device is connected with an external storage unit with the recording medium set therein. Each of the images recorded in the recording medium is read via the external storage unit.

Typical examples of the external storage unit include a CD-R/RW drive, a DVD-R/RW/RAM drive, and an MO drive. The recording medium is any suitable medium corresponding to the selected external storage unit, for example, a CD-R/RW.

The printing device of this preferable application may further include: a memory card reading module that reads each of images recorded in a memory card; and a backup module that stores each of the images read by the memory card reading module as a backup image into the recording medium via the external storage unit.

This structure enables the user to use the two different order sheets and readily select desired images for printing among a large mass of backup images stored in the recording medium.

The technique of the invention is not restricted to the printing device having any of the arrangements discussed above, but may also be actualized by a corresponding processing method that reads and processes images recorded in a recording medium or by a program product that includes a computer program executed by a computer to read and process images recorded in a recording medium. The computer may be a personal computer or an internal computer built in the printing device. The computer program may be stored in a storage medium, such as a flexible disk, a CD-ROM, a magneto-optical disk, or a memory card.

### BRIEF DESCRIPTION OF THE DRAWINGS

FIG. 1 schematically illustrates the configuration of a printing device;

FIG. 2 schematically shows the internal structure of the printing device;

FIG. 3 is a flowchart showing a backup process;

FIG. 4 is a flowchart showing a first half of an order printing process;

FIG. 5 is a flowchart showing a latter half of the order printing process;

FIG. 6 shows one example of a representative image order sheet;

FIG. 7 shows one example of a representative image table;

FIG. 8 shows one example of a print image order sheet; and

FIG. 9 shows one example of a print image table.

### DESCRIPTION OF THE PREFERRED EMBODIMENTS

One mode of carrying out the invention is described below as a preferred embodiment in the following sequence with reference to the accompanied drawings:

A. General Configuration of Printing Device

B. Internal Structure of Printing Device

C. Backup Process

D. Order Printing Process

E. Effects

A. General Configuration of Printing Device

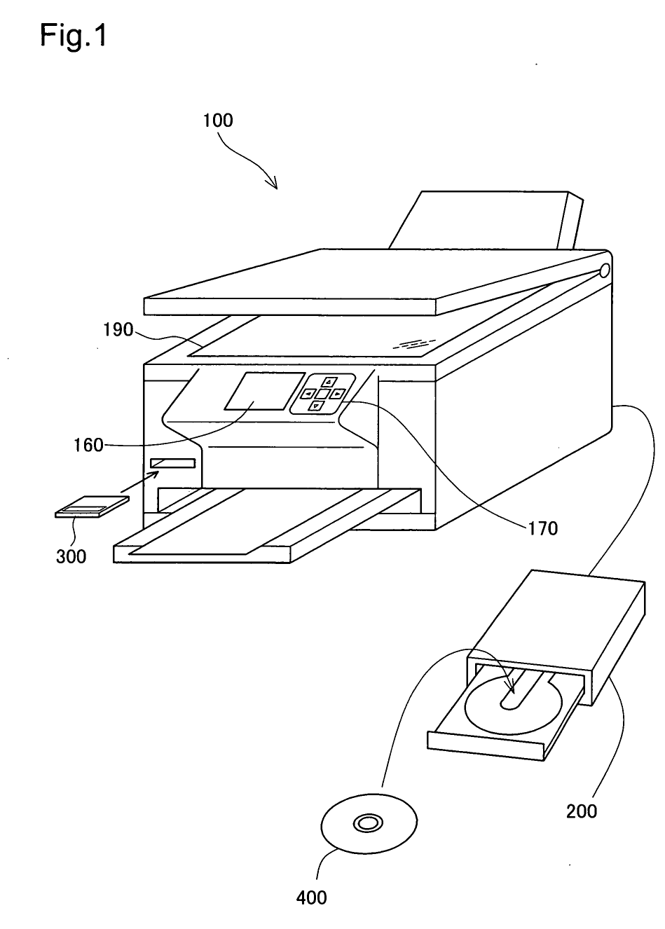

FIG. 1 schematically illustrates the configuration of a printing device 100 in one embodiment of the invention. As illustrated, the printing device 100 of the embodiment is constructed as a complex machine equipped with a scanner 190 that optically takes images. The printing device 100 has a memory card slot 150 to receive a memory card 300 inserted therein, and is connected with an external storage unit 200 via a USB interface.

Typical examples of the memory card 300 inserted into the memory card slot 150 include CompactFlash (registered trademark), SD Memory Card (trademark), Memory Stick (trademark), and SmartMedia (trademark). The external storage unit 200 connected to the printing device 100 may be, for example, a CD-R/RW drive, an MO drive, a DVD-R/RW/RAM drive, or a hard disk drive.

The printing device 100 of this embodiment having the configuration discussed above has the backup function of image data from the memory card 300 to the external storage unit 200, in response to insertion of the memory card 300 with recorded image data into the memory card slot 150 and setting of a writable medium 400 in the external storage unit 200.

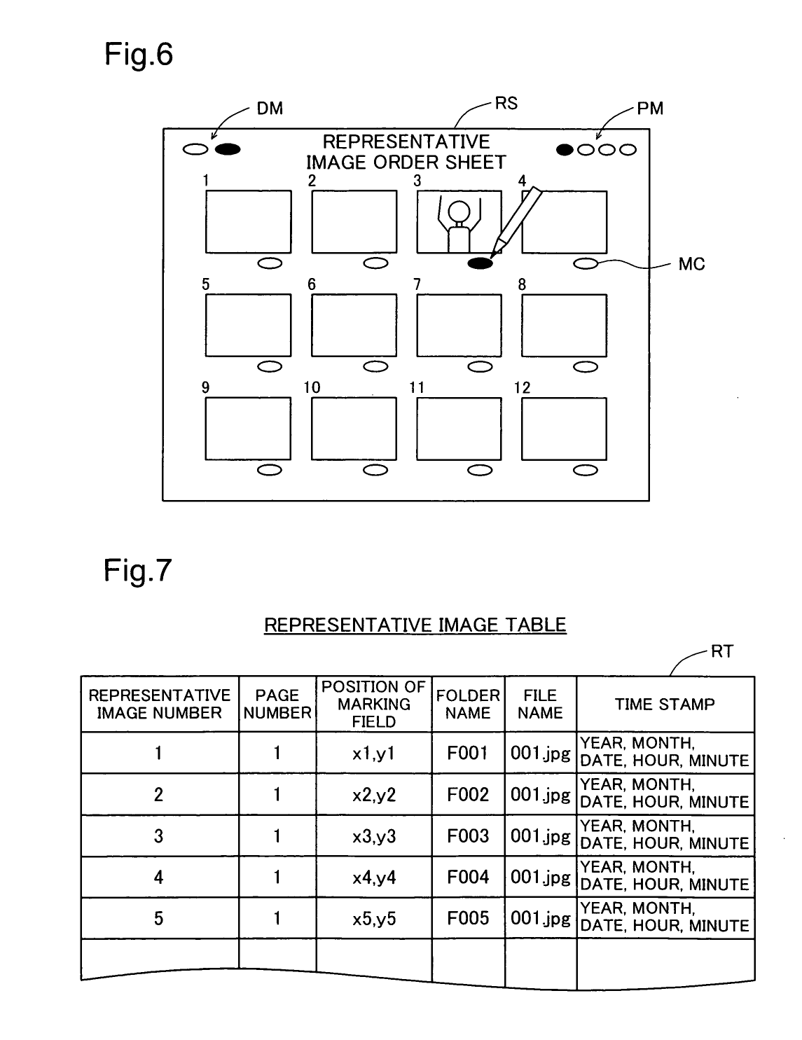

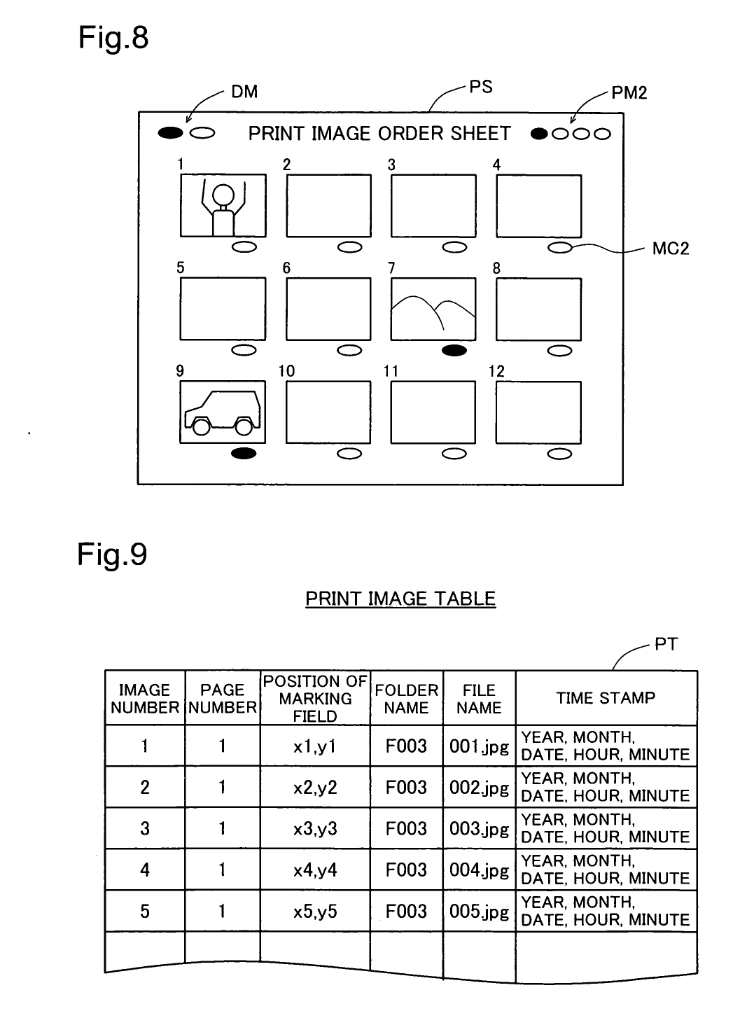

The printing device 100 also has the function of selecting representative images among backup images in the external storage unit 200 and printing a representative image order sheet (see FIG. 6) where the selected representative images are arranged as image indexes. When the user selects a desired representative image in the representative image order sheet and activates the scanner 190 to scan the selected representative image, the printing device 100 prints a print image order sheet (see FIG. 8) where a group of images including the selected representative image are arranged as image indexes. When the user subsequently selects desired images in the print image order sheet and activates the scanner 190 to scan the selected images, the printing device 100 prints the user's selected images. The printing device 100 of this arrangement uses the two different order sheets and enables the user to efficiently select desired images for printing among a large mass of images recorded in the medium 400.

B. Internal Structure of Printing Device

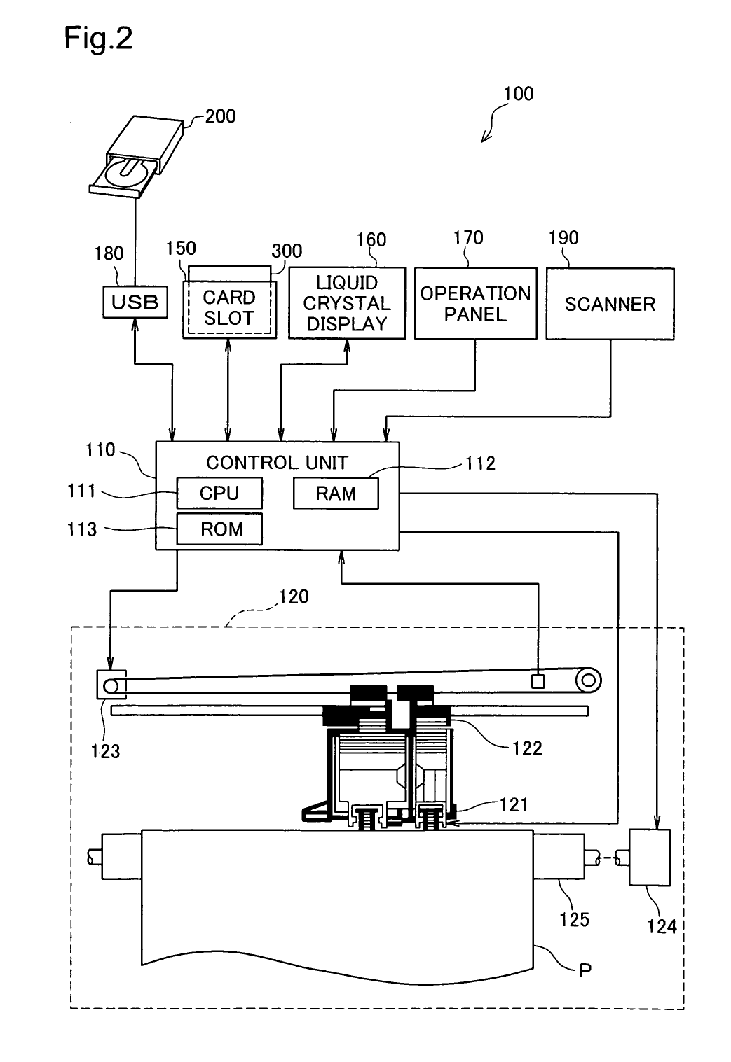

FIG. 2 schematically shows the internal structure of the printing device 100. As illustrated, the printing device 100 has a printing mechanism 120 for printing on printing paper P and a control unit 110 for controlling the whole printing device 100.

The printing mechanism 120 has a print head unit 121 that is mounted on a carriage 122 to eject inks on the printing paper P, a carriage motor 123 that drives the carriage 122 in a main scanning direction, and a paper feed motor 124 that drives a platen 125 to feed the printing paper P in a sub-scanning direction.

The print head unit 121 has ink ejection heads for respective color inks, that is, black, cyan, light cyan, magenta, light magenta, and yellow. Black and color ink cartridges for keeping the respective color inks therein are detachably attached to the carriage 122. The respective color inks supplied from these ink cartridges are ejected onto the printing paper P by adjustment of voltages applied to piezoelectric elements for nozzles on the ink ejection heads. The printing device 100 accordingly creates small dots of the ejected color inks to complete a color printed image.

The control unit 110 is constructed as a computer including a CPU 111, a RAM 112, and a ROM 113. The ROM 113 stores various programs, for example, a print program for controlling the printing mechanism 120 to print images, a backup program for backup of image data from the memory card 300 to the external storage unit 200, and an order print program for order printing with the representative image order sheet and the print image order sheet. The CPU 111 reads these programs from the ROM 113 and executes the programs with the RAM 112 as a working memory.

As illustrated, the control unit 110 is connected to the printing mechanism 120, the memory card slot 150, a liquid crystal display 160 for display of operation windows, an operation panel 170 including multiple operation buttons, a USB port 180 for connection of the external storage unit 200, and the scanner 190.

C. Backup Process

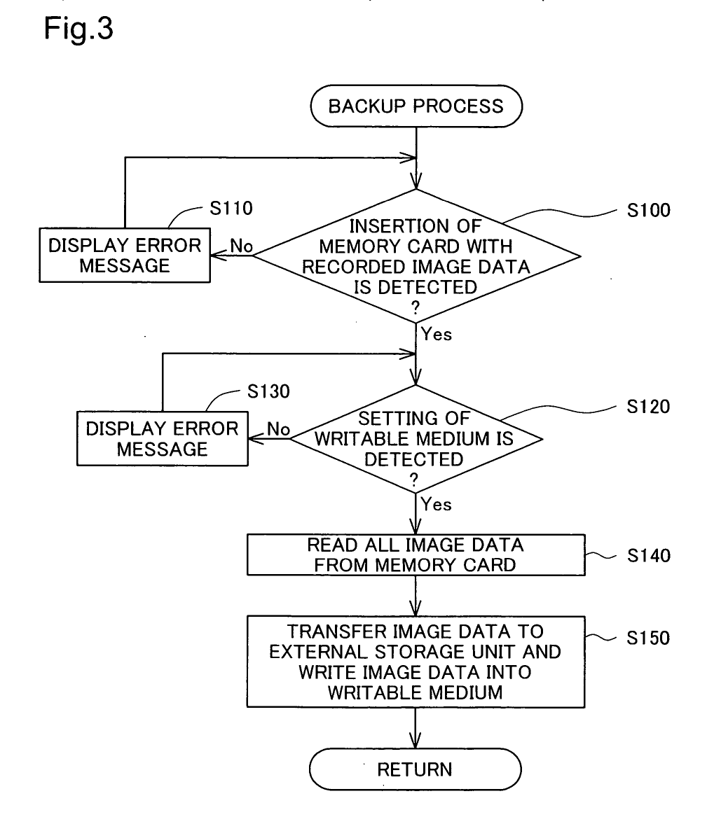

FIG. 3 is a flowchart showing a backup process executed by the CPU 111. The backup process backs up image data from the memory card 300 to the external storage unit 200. The CPU 111 starts the backup process in response to the user's operation of the operation panel 170 to select a backup option in a menu displayed on the liquid crystal display 160.

In the backup process, the CPU 111 first detects insertion of the memory card 300 with recorded image data in the memory card slot 150 (step S100). When no insertion of the memory card 300 is detected or when the inserted memory card 300 has no record of image data at step S100, the CPU 111 displays an error message ‘Insert a memory card with recorded image data’ on the liquid crystal display 160 (step S110) and waits for insertion of the memory card 300 with recorded image data.

Upon detection of insertion of the memory card 300 with recorded image data in the memory card slot 150 at step S100, the CPU 111 subsequently detects setting of the writable medium 400 in the external storage unit 200 (step S120). When no setting of the medium 400 is detected or when the set medium 400 is unwritable at step S120, the CPU 111 displays an error message ‘Set a writable medium’ on the liquid crystal display 160 (step S130) and waits for setting of the writable medium 400.

Upon detection of setting of the writable medium 400 in the external storage unit 200 at step S120, the CPU 111 reads all image data from the memory card 300 (step S140) and transfers the read image data to the external storage unit 200 and writes the image data into the writable medium 400 (step S150).

According to a concrete procedure of step S150, the CPU 111 newly creates one folder having a folder name including a 3-digit serial number in a root directory of the medium 400 and records all the image data read from the memory card 300 into the newly created folder. For example, when a folder created in this cycle has a folder name ‘FOO1’, a subsequent folder created in a next cycle of the backup process has a folder name ‘F002’. Namely each cycle of the backup process creates one new folder having a different folder name and backs up read image data into the created new folder. The letter ‘F’ included in the folder name may be set arbitrarily by the user or may be set automatically by the CPU 111 according to a preset algorithm. The serial number has 3 digits in this embodiment. But this is only illustrative and the serial number may have a less number of digits or a greater number of digits.

The processing of steps S140 and S150 may be replaced by a modified process of collectively storing all the image data read from the memory card 300 into the RAM 112 and collectively transferring the image data from the RAM 112 to the external storage unit 200. Another modified process may read one image data at a time from the memory card 300 and transfer the read image data at each time to the external storage unit 200. The CPU 111 may read only image data having a preset extension, for example, ‘jpg’ or ‘gif’ at step S140. This arrangement effectively prevents unnecessary backup of non-image data.

The backup process does not require an independent personal computer but enables image data recorded in the memory card 300 to be readily backed up in a high-capacity medium, such as a CD-R. In this embodiment, the CPU 111 starts the backup process in response to the user's selection of the backup option on the operation panel 170. The CPU 111 may automatically start the backup process in response to detection of insertion of the memory card 300 into the memory card slot 150.

D. Order Printing Process

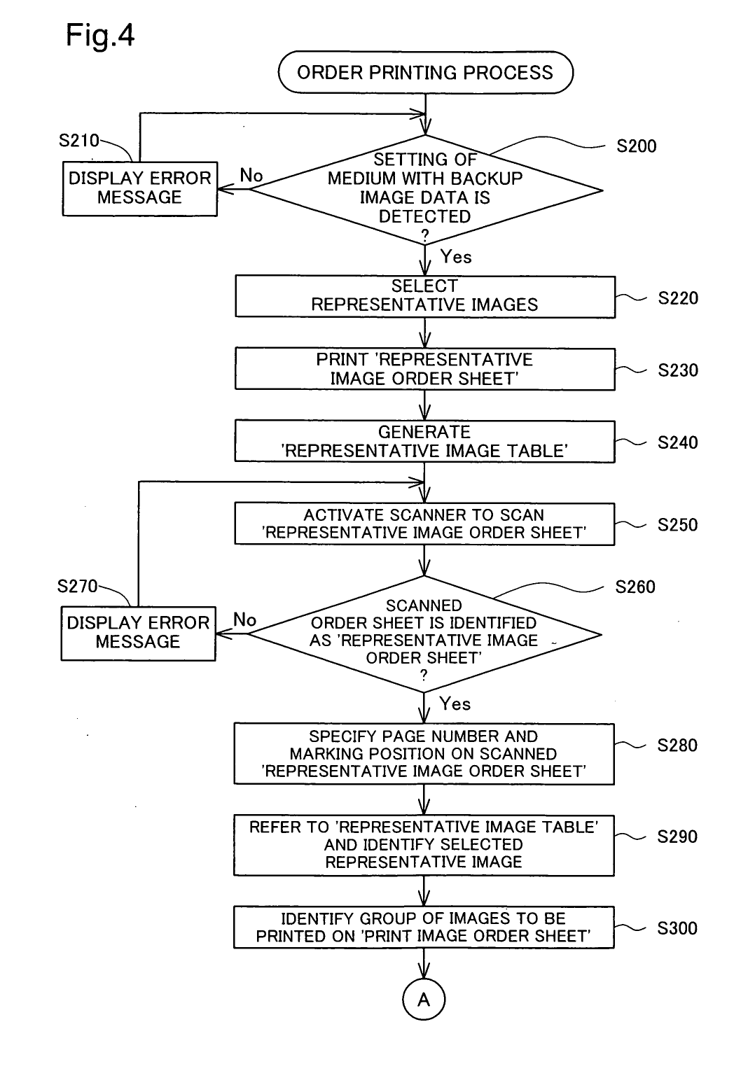

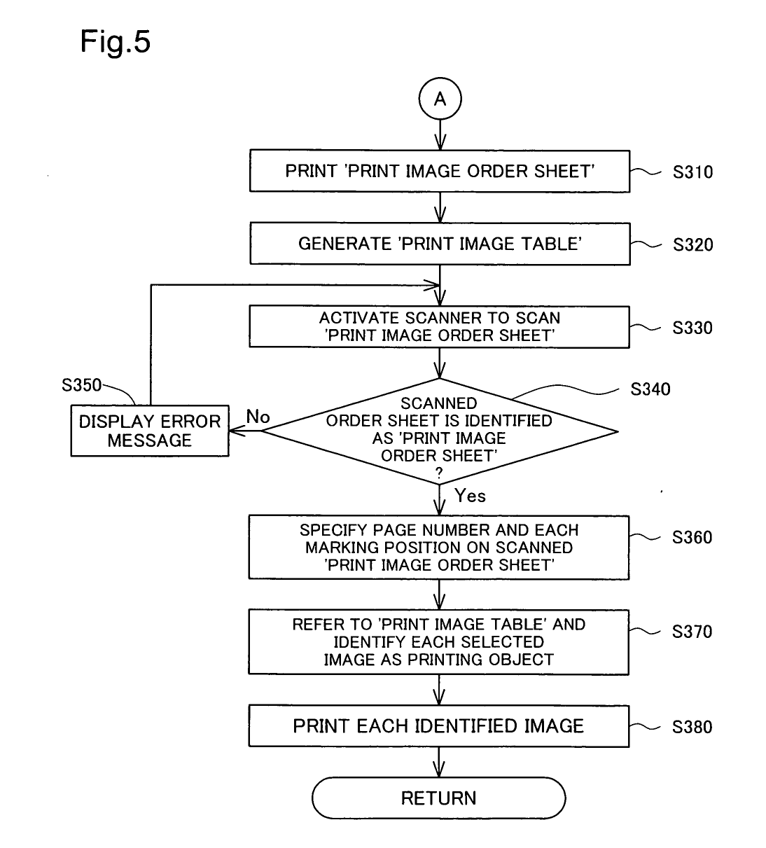

FIGS. 4 and 5 are flowcharts showing an order printing process executed by the CPU 111. The order printing process enables the user to select desired image for printing among the backup images in the external storage unit 200. The CPU 111 starts the order printing process in response to the user's operation of the operation panel 170 to select an order printing option in the menu displayed on the liquid crystal display 160.

In the order printing process, the CPU 111 first detects setting of the medium 400 with backup image data in the external storage unit 200 (step S200). When no setting of the medium 400 is detected, the CPU 111 displays a preset message, which urges the user to set the medium 400 with backup image data, on the liquid crystal display 160 (step S210) and waits for setting of the medium 400 in the external storage unit 200. When folders included in the medium 400 set in the external storage unit 200 have different folder names from those allocated in the backup process, for example, ‘F001’ and ‘F002’, the CPU 111 may identify the medium 400 unprocessable and display a preset error message.

Upon detection of setting of the medium 400 with backup image data in the external storage unit 200, the CPU 111 selects representative images among the backup images recorded in the medium 400 (step S220). According to a concrete procedure, the CPU 111 selects a first image in a recording order from each folder created in the medium 400, as a representative image. The medium 400 stores multiple groups of images in multiple folders. The CPU 111 accordingly selects one representative image from each group of images stored in each folder at step S220.

The order printing process of this embodiment selects a first image in the recording order from each folder as a representative image. This is, however, not restrictive, but the representative image may be a middle image or a last image of each folder in the recording order. Another method may select representative images at random from the respective folders. In a medium of another structure with no creation of folders, the procedure may collect images with time stamps of an identical date, an identical month, or an identical year as a group of images and select an image of an earliest time stamp, a latest time stamp, or an intermediate time stamp from each group of images as a representative image. One possible modification of this procedure may select representative images at random from these groups of images.

The CPU 111 prints a representative image order sheet RS including the representative images selected at step S220 and arranged as image indexes (step S230).

FIG. 6 shows one example of the representative image order sheet RS. Each representative image order sheet RS of this embodiment has a space for printing up to 12 representative images, that is, 4 images in the horizontal direction×3 images in the vertical direction. When the selected representative images are more than 12, multiple representative image order sheets RS are printed. A representative image number allocated to each representative image is printed on the upper left corner of the representative image, and a marking field MC is printed on the lower right corner of the representative image to be filled in by the user with a writing instrument. An order sheet identification mark DM is printed on the upper left corner of the representative image order sheet RS for discrimination between the representative image order sheet RS and a print image order sheet PS (described later). A page number identification mark PM representing the page number of the representative image order sheet RS is printed on the upper right corner of the representative image order sheet RS.

After printing the representative image order sheet RS, the CPU 111 generates a representative image table RT, which defines each representative image by the position of the corresponding marking field MC on the representative image order sheet RS, and stores the generated representative image table RT into the RAM 112 (step S240).

FIG. 7 shows one example of the representative image table RT. The representative image table RT includes a representative image number allocated to each representative image printed on the representative image order sheet RS, a page number of the representative image order sheet RS with the print of the representative image, the position of a marking field MC corresponding to the representative image, a folder name with storage of the representative image, a file name of the representative image, and a time stamp of the representative image.

The user selects a desired representative image among the representative images on the representative image order sheet RS printed at step S230 and fills in the marking field MC corresponding to the selected representative image with a writing instrument. In the illustrated example of FIG. 6, the user has filled in the marking field MC corresponding to a representative image with a representative image number ‘3’. After selection of the desired representative image, the user sets the representative image order sheet RS with marking in the scanner 190.

The CPU 111 then scans the representative image order sheet RS set in the scanner 190 in response to the user's scan start operation on the operation panel 170 (step S250). The CPU 111 analyzes the scanned image and identifies whether the scanned order sheet is the representative image order sheet RS based on the order sheet identification mark DM (step S260). When the order sheet identification mark DM does not indicate the representative image order sheet RS, the CPU 111 displays a preset error message, which urges the user to set the representative image order sheet RS in the scanner 190, on the liquid crystal display 160 (step S270) and goes back to step S250.

When the order sheet identification mark DM indicates the representative image order sheet RS, on the other hand, the CPU 111 further analyzes the image scanned at step S250 and specifies the page number and the marking position, that is, the position of the filled-in marking field MC, on the scanned representative image order sheet RS (step S280). The CPU 111 then refers to the representative image table RT (see FIG. 7) and identifies the user's selected representative image based on the specified page number and the specified position of the filled-in marking field MC (step S290).

After identification of the user's selected representative image, the CPU 111 refers to the representative image table RT, specifies a folder including the representative image identified at step S290, and identifies a group of images recorded in the specified folder as printing objects on the print image order sheet PS (described later) (step S300). When each of the representative images selected at step S220 is extracted from each collection of images having time stamps of an identical date, an identical month, or an identical year, the procedure of step S300 compares the time stamp of the representative image identified at step S290 with the time stamp of each image and identifies a collection of images having time stamps of the identical date, the identical month, or the identical year with the time stamp of the identified representative image as printing objects on the print image order sheet PS.

Referring to the flowchart of FIG. 5, the CPU 111 reads the group of images identified at step S300 from the medium 400 and prints a print image order sheet PS including the identified group of images arranged as image indexes (step S310).

FIG. 8 shows one example of the print image order sheet PS. Each print image order sheet PS of this embodiment has a space for printing up to 12 images, that is, 4 images in the horizontal direction×3 images in the vertical direction. When the identified image group includes more than 12 images, multiple print image order sheets PS are printed. An image number allocated to each image is printed on the upper left corner of the image, and a marking field MC2 is printed on the lower right corner of the image to be filled in by the user with a writing instrument. The order sheet identification mark DM is printed on the upper left corner of the print image order sheet PS for discrimination between the representative image order sheet RS and the print image order sheet PS. A page number identification mark PM2 representing the page number of the print image order sheet PS is printed on the upper right corner of the print image order sheet PS.

After printing the print image order sheet PS, the CPU 111 generates a print image table PT, which defines each image by the position of the corresponding marking field MC2 on the print image order sheet PS, and stores the generated print image table PT into the RAM 112 (step S320).

FIG. 9 shows one example of the print image table PT. The print image table PT includes an image number allocated to each image printed on the print image order sheet PS, a page number of the print image order sheet PS with the print of the image, the position of a marking field MC2 corresponding to the image, a folder name with storage of the image, a file name of the image, and a time stamp of the image.

The user selects one or multiple desired images for printing among the images on the print image order sheet PS printed at step S310 and fills in the marking fields MC2 corresponding to the selected images with a writing instrument. In the illustrated example of FIG. 8, the user has filled in the marking fields MC2 corresponding to images with image numbers ‘7’ and ‘9’. After selection of the desired images, the user sets the print image order sheet PS with marking in the scanner 190.

The CPU 111 then scans the print image order sheet PS set in the scanner 190 in response to the user's scan start operation on the operation panel 170 (step S330). The CPU 111 analyzes the scanned image and identifies whether the scanned order sheet is the print image order sheet PS based on the order sheet identification mark DM (step S340). When the order sheet identification mark DM does not indicate the print image order sheet PS, the CPU 111 displays a preset error message, which urges the user to set the print image order sheet PS in the scanner 190, on the liquid crystal display 160 (step S350) and goes back to step S330.

When the order sheet identification mark DM indicates the print image order sheet PS, on the other hand, the CPU 111 further analyzes the image scanned at step S330 and specifies the page number and the marking position, that is, the position of the filled-in marking field MC2, on the scanned print image order sheet PS (step S360). The CPU 111 then refers to the print image table PT (see FIG. 9) and identifies the user's selected image as a printing object based on the specified page number and the specified position of the filled-in marking field MC2 (step S370). When the user has filled in multiple marking fields MC2 on the print image order sheet PS, multiple images corresponding to the multiple filled-in marking fields MC2 are identified as printing objects at step S370.

The CPU 111 reads image data representing the images identified as the printing objects at step S370 from the medium 400 and controls the printing mechanism 120 to print the identified images (step S380).

E. Effects

As described above, the printing device 100 of the embodiment first prints the representative image order sheet RS showing the representative images selected among the backup images in the medium 400. The user selects a desired representative image on the representative image order sheet RS. The printing device 100 subsequently prints the print image order sheet PS showing the identified group of images including the selected representative image. The user selects one or multiple desired images for printing on the print image order sheet PS. The printing device 100 eventually prints the user's selected images. The printing device 100 of the embodiment uses the two different order sheets and facilitates the user's selection of desired images in a hierarchical manner. This arrangement enables the user to efficiently select desired images for printing among a large mass of images recorded in the medium 400.

The embodiment discussed above is to be considered in all aspects as illustrative and not restrictive. There may be many modifications, changes, and alterations without departing from the scope or spirit of the main characteristics of the present invention. For example, the printing device 100 of the above embodiment uses the two different order sheets. This is, however, not restrictive and the use of three or more different order sheets enables selection of images on a deeper hierarchical level.

In the printing device 100 of the embodiment, the user fills in a marking field on each order sheet to select a desired representative image or to select each desired image as a printing object. One modified structure may inherently allocate a barcode to each representative image or to each image as a possible printing object. Each order sheet of this modified structure includes barcodes corresponding to respective representative images or corresponding to respective images as possible printing objects, instead of the marking fields. In this modified structure, the printing device 100 is connected with a barcode reader via a USB interface. The user operates the barcode reader to read a selected barcode on the order sheet to identify a desired representative image or each desired image as a printing object. The barcode may be replaced by any suitable 2-dimensional code, for example, a QR code.

The order printing process of the embodiment selects desired images for printing among the backup images in the medium 400. The order printing process is also preferably applicable to select desired images for printing among images recorded in the memory card 300. With recent development of high-capacity memory cards, a large mass of images may be recorded in one memory card.

The printing device 100 of the embodiment automatically extracts a first image in the recording order from each folder recorded in the medium 400, as a representative image. The user may manually select a desired image from each group of images as a representative image. The user may manually set a relation of each representative image to an image group including the representative image.

What is claimed is:

1. A printing device that reads and processes images recorded in a recording medium, said printing device comprising:
a representative image selection module that selects a representative image from each of multiple image groups recorded in the recording medium;
a first order sheet printing module that prints a first order sheet, where the representative images selected by said representative image selection module are arranged as image indexes and first identification marks for identifying the respective representative images are provided corresponding to the representative images;
an image group identification module that receives a user's selection of a representative image based on a corresponding first identification mark and identifies an image group including the user's selected representative image among the multiple image groups;
a second order sheet printing module that prints a second order sheet, where images included in the image group identified by said image group identification module are arranged as image indexes and second identification marks for identifying the respective images are provided corresponding to the images;
an image identification module that receives the user's selection of at least one image based on a corresponding second identification mark and identifies the user's selected at least one image in the image group identified by said image group identification module; and
a processing module that reads the at least one image identified by said image identification module from the recording medium and processes the at least one image read from the recording medium.

2. A printing device in accordance with claim 1, wherein said processing module prints the at least one image read from the recording medium.

3. A printing device in accordance with claim 1, wherein the recording medium stores the multiple image groups respectively recorded in multiple different folders, and
said representative image selection module selects a representative image among images recorded in each of the multiple different folders according to a predetermined rule.

4. A printing device in accordance with claim 3, wherein said representative image selection module selects either a first image or a last image in a recording order among the images recorded in each folder, as the representative image.

5. A printing device in accordance with claim 1, wherein each of the images recorded in the recording medium has time-related information, and
said representative image selection module collects images having a time stamp of an identical date, an identical month, or an identical year into one image group and selects a representative image out of each image group according to a predetermined rule.

6. A printing device in accordance with claim 5, wherein said representative image selection module selects an image having an earliest time stamp, a latest time stamp, or an intermediate time stamp among the images included in each image group, as the representative image.

7. A printing device in accordance with claim 1, wherein said first order sheet printing module prints a first marking field, which is to be filled in by the user with a writing instrument in response to the user's selection, as the first identification mark, and
said second order sheet printing module prints a second marking field, which is to be filled in by the user with the writing instrument in response to the user's selection, as the second identification mark.

8. A printing device in accordance with claim 7, said printing device being connected with a scanner,
wherein said image group identification module controls the scanner to scan the first order sheet and receives a representative image specified by the user's fill-in operation in a corresponding first marking field, as the user's selection of the representative image, and
said image identification module controls the scanner to scan the second order sheet and receives at least one image specified by the user's fill-in operation in a corresponding second marking field, as the user's selection of the at least one image.

9. A printing device in accordance with claim 1, wherein said first order sheet printing module prints a barcode inherently allocated to each of the representative images, as the first identification mark, and
said second order sheet printing module prints a barcode inherently allocated to each of the images, as the second identification mark.

10. A printing device in accordance with claim 9, said printing device being connected with a barcode reader,
wherein said image group identification module receives the user's selection of the representative image, in response to a barcode reading signal received from the barcode reader, and
said image identification module receives the user's selection of the at least one image, in response to a barcode reading signal received from the barcode reader.

11. A printing device in accordance with claim 1, said printing device being connected with an external storage unit having the recording medium set therein,
wherein each of the images recorded in the recording medium is read via the external storage unit.

12. A printing device in accordance with claim 11, said printing device further comprising:
a memory card reading module that reads each of images recorded in a memory card; and
a backup module that stores each of the images read by said memory card reading module as a backup image into the recording medium via the external storage unit.

13. A processing method for reading and processing images recorded in a recording medium, said processing method comprising:
selecting a representative image from each of multiple image groups recorded in the recording medium;
printing a first order sheet, where the selected representative images are arranged as image indexes and first identification marks for identifying the respective representative images are provided corresponding to the representative images;
receiving a user's selection of a representative image based on a corresponding first identification mark and identifying an image group including the user's selected representative image among the multiple image groups;
printing a second order sheet, where images included in the identified image group are arranged as image indexes and second identification marks for identifying the respective images are provided corresponding to the images;
receiving the user's selection of at least one image based on a corresponding second identification mark and identifying the user's selected at least one image in the identified image group; and
reading the at least one identified image from the recording medium and processing the at least one image read from the recording medium.

14. A program product that causes a computer to read and process images recorded in a recording medium,
said program product comprising:
a computer readable storage medium; and
a program code that is stored in said storage medium and is read and executed by the computer to attain the functions of:
selecting a representative image from each of multiple image groups recorded in the recording medium;
printing a first order sheet, where the selected representative images are arranged as image indexes and first identification marks for identifying the respective representative images are provided corresponding to the representative images;
receiving a user's selection of a representative image based on a corresponding first identification mark and identifying an image group including the user's selected representative image among the multiple image groups;
printing a second order sheet, where images included in the identified image group are arranged as image indexes and second identification marks for identifying the respective images are provided corresponding to the images;
receiving the user's selection of at least one image based on a corresponding second identification mark and identifying the user's selected at least one image in the identified image group; and
reading the at least one identified image from the recording medium and processing the at least one image read from the recording medium.

15. A storage medium where the program code included in a program product in accordance with claim 14 is stored in a computer readable manner.
